(19) United States
(12) Patent Application Publication
(10) Pub. No.: US 2024/0308634 A1
(43) Pub. Date: Sep. 19, 2024

(54) SHAPE MEMORY ALLOY VARIABLE BUOYANCE ENGINE

(71) Applicant: Raytheon Company, Waltham, MA (US)

(72) Inventor: Caitlin C. Bogdan, Little Compton, RI (US)

(21) Appl. No.: 18/185,573

(22) Filed: Mar. 17, 2023

(51) Int. Cl. B63G 8/24; B63G 8/00; B63G 8/04; B63G 8/18; F03G 7/06

(52) U.S. Cl. CPC B63G 8/24; B63G 8/001; B63G 8/04; B63G 8/18; F03G 7/0614; B63G 2008/004

(57) ABSTRACT

A variable buoyance engine includes a pressure vessel, a reservoir, an external bladder, a non-compressible fluid inside the reservoir and the external bladder, and a drive system. The drive system includes a shape memory alloy actuator, a piston attached to the actuator, a power source connected to the actuator, and a controller configured to control application of power to the actuator. The power source is configured to cause the actuator to change temperature and deform when power is applied to the actuator thereby moving the piston from a first position to a second position. The reservoir and external bladder are configured to retain, without leakage, the non-compressible working fluid. The external bladder is configured to receive the non-compressible working fluid from the reservoir when the actuator moves the piston from a first position to a second position to create a second, positive buoyancy state and to expel the non-compressible working fluid from the external bladder to the reservoir when the actuator moves the piston from the second position to the first position to create a first, negative buoyancy state.

### BACKGROUND

The present disclosure relates generally to variable buoyance engines and, more particularly, to variable buoyance engines for underwater vehicles such as gliders and floats.

Various types of autonomous underwater vehicles (AUVs) employ variable buoyancy propulsion engines instead of traditional propellers or thrusters. AUVs can be used for a variety of civil and military uses, including conducting surveys of sea floors, underwater water quality, and similar research surveys. AUVs can be used for a variety of other applications as well. For many applications, AUVs are equipped with a variety of electronic, optical, and acoustic sensors, many of which can be subject to electrical and acoustic interference. Conventional variable buoyancy engines use a rotational motor drive, which can be both electrically and acoustically noisy. As such, conventional variable buoyancy engines can limit operations of AUVs either by causing interference with sensors on the AUVs or by requiring the conventional variable buoyancy engines to be shut off for periods of time to permit interference-free operation of the onboard sensors.

### SUMMARY

A variable buoyance engine includes a pressure vessel, a reservoir, an external bladder in fluid communication with the reservoir, a non-compressible fluid disposed inside the reservoir and the external bladder, and a drive system disposed inside the reservoir. The drive system includes a deformable shape memory alloy actuator, a piston attached to the deformable shape memory alloy actuator, a power source connected to the deformable shape memory alloy actuator, and a controller configured to control application of power from the power source to the deformable shape memory alloy actuator. The power source is configured to cause the deformable shape memory alloy actuator to change temperature and deform when power is applied to the deformable shape memory alloy actuator thereby moving the piston from a first position to a second position. The reservoir and external bladder are configured to retain, without leakage, the non-compressible working fluid. The external bladder is configured to receive the non-compressible working fluid from the reservoir when the deformable shape memory alloy actuator moves the piston from a first position to a second position to create a second, positive buoyancy state and to expel the non-compressible working fluid from the external bladder to the reservoir when the deformable shape memory alloy actuator moves the piston from the second position to the first position to create a first, negative buoyancy state.

An autonomous underwater vehicle includes an underwater vehicle body configured to operate in an underwater environment. The underwater vehicle further includes a variable buoyance system as discussed above. The pressure vessel is part of the structure of the underwater vehicle body, the reservoir is positioned inside the underwater vehicle body, and the external bladder is positioned external to the underwater vehicle body. The autonomous underwater vehicle is configured to descend in the underwater environment when the variable buoyance engine is in a first, negative buoyancy state and the autonomous underwater vehicle is configured to ascend in the underwater environment when the variable buoyance engine is in a second, positive buoyancy state.

A method for propelling an autonomous underwater vehicle in an underwater environment includes providing an autonomous underwater vehicle as discussed above in an underwater environment, controlling the autonomous underwater vehicle through a period of descending in the underwater environment when the variable buoyance engine is in a first, negative buoyancy state, and controlling the autonomous underwater vehicle through a period of ascending in the underwater environment when the variable buoyance engine is in a second, positive buoyancy state.

### BRIEF DESCRIPTION OF THE DRAWINGS

FIG. 1 is a perspective view of an autonomous underwater vehicle (AUV) glider.

FIG. 2 is a schematic view of an autonomous underwater float.

FIG. 3A is a schematic diagram of a prior art motor driven variable buoyance engine in a first buoyancy state.

FIG. 3B is a schematic diagram of a prior art motor driven variable buoyance engine in a second buoyancy state.

FIG. 4A is a schematic diagram of a variable buoyance engine of the present disclosure in a first buoyancy state.

FIG. 4B is a schematic diagram of a variable buoyance engine of the present disclosure in a second buoyancy state.

FIG. 5A is a schematic diagram of another variable buoyance engine of the present disclosure in a first buoyancy state.

FIG. 5B is a schematic diagram of another variable buoyance engine of the present disclosure in a second buoyancy state.

### DETAILED DESCRIPTION

The present disclosure is directed to autonomous underwater vehicles (AUVs) that replace the rotational motor drive in a conventional variable buoyancy engine with a drive that incorporates shape memory alloys (SMA). A SMA drive can include a deformable SMA actuator attached to a moving plate or piston inside a cylinder or reservoir. The cylinder or reservoir is filled with a non-compressible working fluid that is used to inflate or deflate a bladder external to the underwater glider to change overall buoyancy of the AUV. Using a SMA drive can reduce both electrical and acoustic noise compared to a conventional variable buoyancy engine with a rotational motor drive.

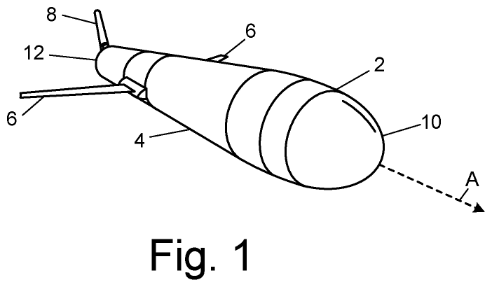

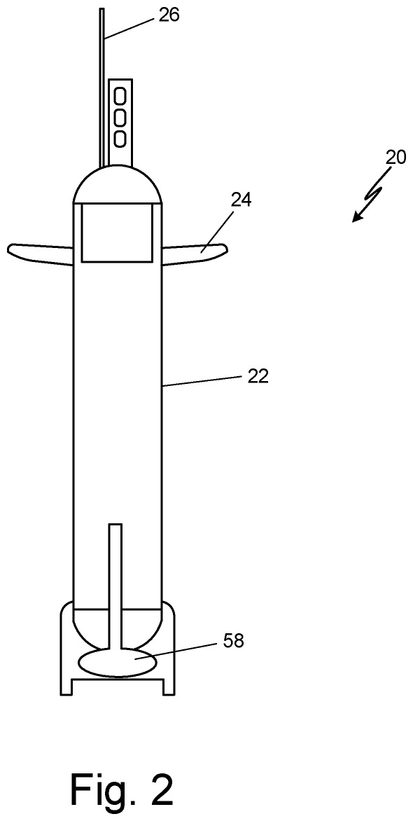

Various types of AUVs are used for a variety of civil and military uses, including conducting surveys of sea floors, underwater water quality, and similar research surveys. Exemplary AUVs and other autonomous underwater systems include underwater gliders (see FIG. 1) and floats (see FIG. 2). FIG. 1 is a perspective view of an underwater glider 2. The underwater glider 2 includes a streamlined glider body 4 with at least two hydrofoils 6 and at least one vertical stabilizer 8 to direction motion of the underwater glider 2 in an underwater environment. In operation, the underwater glider 2 moves in a forward direction (i.e., in the direction of a streamlined nose 10) along longitudinal axis A. The underwater glider 2 is typically propelled by variable buoyancy propulsion system (not shown), discussed further below, contained within the streamlined glider body 4. The streamlined glider body 4 is configured to move smoothly through an underwater environment with limited friction using convention nautical design techniques. As such, the streamlined glider body 4 typically includes the streamlined nose 10 and a blunt aft end 12. The at least two hydrofoils 6 are configured to direct the underwater glider 2 in a forward direction along longitudinal axis A as the underwater glider 2 descends and ascends in an underwater environment when in operation. The at least one vertical stabilizer 8 is configured to orient the direction of travel of the underwater glider 2 along the longitudinal axis A as the underwater glider 2 descends and ascends in an underwater environment when in operation. In other embodiments, underwater glider 2 may have more than one vertical stabilizer 8. In other embodiments, underwater glider 2 may also have one or more horizontal stabilizers configured to control other aspects of the direction of travel of the underwater glider 2 when in operation.

FIG. 2 is a schematic of a float 20. The float 20 includes a float body 22, which may optionally include a stability disk 24 to stabilize direction motion of the float 20 in an underwater environment. In operation, the float 20 descends and ascends as controlled by a variable buoyancy engine (not shown), discussed further below, contained within the float body 22. The float body 22 is configured to move smoothly in an underwater environment with using convention nautical design techniques. Once deployed into an underwater environment, the float 20 typically descends to a selected depth of neutral buoyancy, collecting data from sensors (not shown) as it goes. After a pre-determined time at the selected depth of neutral buoyancy, at which the float 20 continues to collect data from its sensors, a controller (not shown) in the float 20 directs the variable buoyance engine to cause the float 20 to ascend to a point at which an on-board antenna 26 can establish communication with an off-board data collection system (e.g., a shore installation, a vessel at sea, a satellite, etc.) to off-load data collected by the sensors on the float 20. In some embodiments, the float 20 can repeat the data collection cycle. In other embodiments, the float 20 can be picked up for reuse or abandoned. In some embodiments, the float 20 can be free floating, such as free floating in currents to which it is exposed. In other embodiments, the float 20 can be tethered or anchored so it is less impacted by currents and primarily descends and ascends in its underwater environment.

Variable buoyancy engines used by AUVs operate by modifying the buoyancy of the AUV to cause the AUV to descend or ascend when in operation in an underwater environment. The AUV descends in the underwater environment when it is in a first or negative buoyancy state. The AUV ascends in the underwater environment when it is in a second or positive buoyancy state. The AUV neither descends nor ascends in the underwater environment when it is in a third or neutral buoyancy state. Each buoyancy state is affected by the mass and volume of the AUV and the conditions (e.g., salinity, temperature, density, etc.) of the underwater environment. Knowing the conditions of the underwater environment and the mass and volume of the AUV, an operator of the AUV can establish operational conditions for the AUV such that the neutral buoyancy state corresponds to a desired depth in the underwater environment.

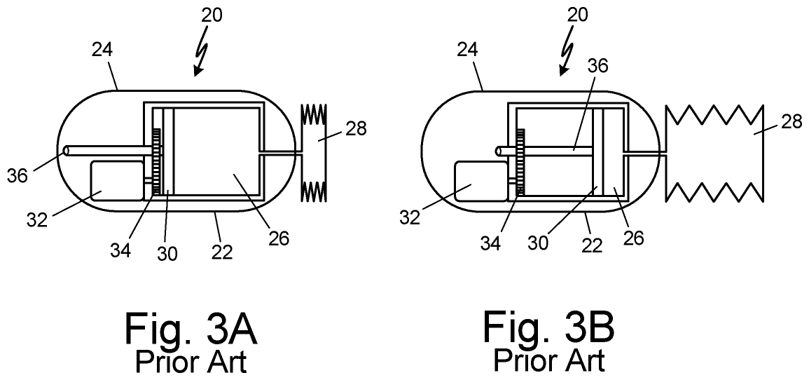

Various variable buoyancy engines are known in the art. One type of variable buoyancy engine, a piston-driven oil, constant mass, variable volume system, in shown in FIGS. 3A and 3B. These Figs. show a schematic diagram of a prior art motor driven variable buoyance system 30 in a first buoyancy state (FIG. 3A) and second buoyancy state (FIG. 3B). The variable buoyance system 30 includes a drive mechanism 32 positioned primarily inside a pressure vessel 34. The drive mechanism 32 includes a cylinder 36, external bladder 38, piston 40, motor 42, gearing 44, and piston rod 46. The cylinder 36 and external bladder 38 are filled with a non-compressible fluid that can flow between the cylinder 36 and external bladder 38 based on the position of the piston 40. The cylinder 36 is positioned inside the pressure vessel 34 (and inside the AUV), while the external bladder 38 is positioned external to the pressure vessel (and outside the AUV). Because the non-compressible working fluid is contained within the cylinder 36 and external bladder 38, the variable buoyance system 30 has a constant mass. Both the cylinder 36 and external bladder 38 have variable volumes that result in the buoyancy of the variable buoyance system 30 changing depending on the position of non-compressible fluid within the cylinder 36 and external bladder 38. With the piston 40 positioned as shown in FIG. 3A, the non-compressible working fluid is contained primarily within the cylinder 36 and the variable buoyance system 30 in a first buoyancy state-a negative buoyancy state. With the piston 40 positioned as shown in FIG. 3B, the non-compressible working fluid is contained primarily within the external bellows 38 and the variable buoyance system 30 in a second buoyancy state-a positive buoyancy state. The motor driven variable buoyance system 30 shown in FIGS. 3A and 3B exhibits the challenge that prior art systems have: because it relies on a motor 42 and gearing 44 to move the piston 40 (and non-compressible working fluid) from the first buoyancy state (FIG. 3A) to the second buoyancy state (FIG. 3B), it generates electrical and acoustic noise that can interfere with the operation of an underwater glider in which the motor driven variable buoyance system 30 is installed.

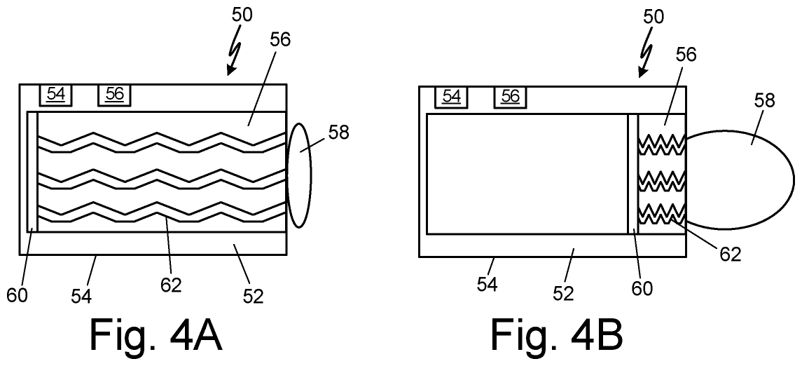

As disclosed, using deformable shape memory alloy (SMA) actuators to drive a piston instead of a motor and gearing results in a variable buoyance engine 50, shown in FIGS. 4A and 4B, that generates less electrical and acoustic noise than prior art systems. FIGS. 4A and 4B are schematic diagrams of a variable buoyance engine 50 of the present disclosure in a first buoyancy state (FIG. 4A) and a second buoyancy state (FIG. 4B). The variable buoyance engine 50 includes a drive mechanism 52 positioned primarily inside a pressure vessel 54. The drive mechanism 52 includes a reservoir 56, external bladder 58, piston 60, deformable SMA actuator 62, power source 64, and controller 66. The reservoir 56 and external bladder 58 are filled with a non-compressible working fluid that can flow between the reservoir 56 and external bladder 58 based on the position of the piston 60. As a result, the external bladder 58 is in fluid communication with the reservoir 56. The reservoir 56 and external bladder 58 are configured to retaining the non-compressible working fluid without leakage. The reservoir 56 is positioned inside the pressure vessel 54, while the external bladder 58 is positioned external to the pressure vessel 54. Because the non-compressible working fluid is contained within the reservoir 56 and external bladder 58, the variable buoyance system 50 has a constant mass. Both the reservoir 56 and external bladder 58 have variable volumes that result in the buoyancy of the variable buoyance engine 50 changing depending on the position of non-compressible working fluid within the reservoir 56 and external bladder 58. With the piston 60 positioned as shown in FIG. 4A, the non-compressible working fluid is contained primarily within the reservoir 56 and the variable buoyance engine 50 in a first buoyancy state-a negative buoyancy state. With the piston 60 positioned as shown in FIG. 4B, the non-compressible fluid is contained primarily within the external bellows 58 and the variable buoyance engine 50 in a second buoyancy state-a positive buoyancy state.

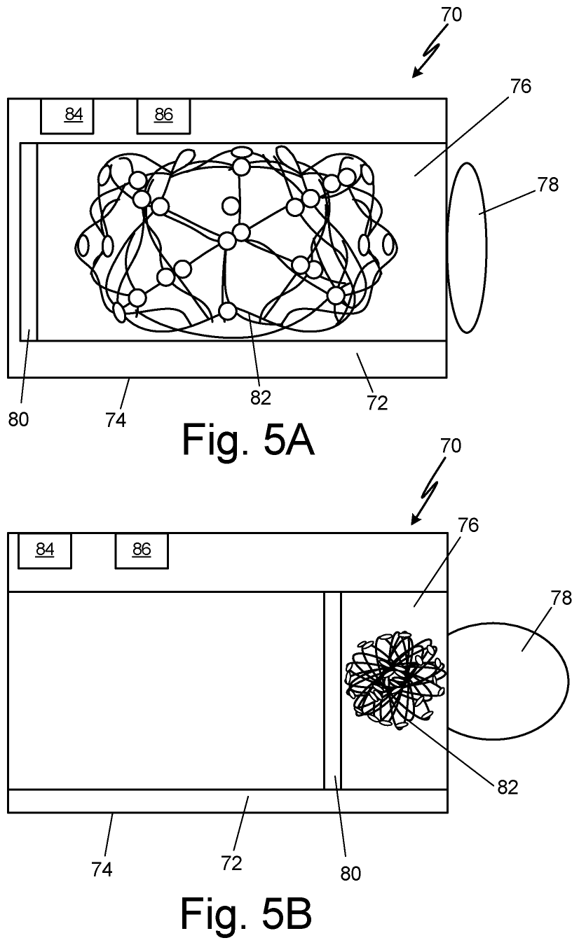

FIGS. 5A and 5B are schematic diagrams of another variable buoyance engine 70 of the present disclosure in a first buoyancy state (FIG. 5A) and a second buoyancy state (FIG. 5B). The variable buoyance engine 70 includes a drive mechanism 72 positioned primarily inside a pressure vessel 74. The drive mechanism 72 includes a reservoir 76, external bladder 78, piston 80, deformable SMA actuator 82, power source 84, and controller 86. The reservoir 76 and external bladder 78 are filled with a non-compressible working fluid that can flow between the reservoir 76 and external bladder 78 based on the position of the piston 80. As a result, the external bladder 78 is in fluid communication with the reservoir 76. The reservoir 76 and external bladder 78 are configured to retaining the non-compressible working fluid without leakage. The reservoir 76 is positioned inside the pressure vessel 74, while the external bladder 78 is positioned external to the pressure vessel 74. Because the non-compressible working fluid is contained within the reservoir 76 and external bladder 78, the variable buoyance system 70 has a constant mass. Both the reservoir 76 and external bladder 78 have variable volumes that result in the buoyancy of the variable buoyance engine 70 changing depending on the position of non-compressible working fluid within the reservoir 76 and external bladder 78. With the piston 80 positioned as shown in FIG. 5A, the non-compressible working fluid is contained primarily within the reservoir 76 and the variable buoyance engine 70 in a first buoyancy state-a negative buoyancy state. With the piston 80 positioned as shown in FIG. 5B, the non-compressible fluid is contained primarily within the external bellows 78 and the variable buoyance engine 70 in a second buoyancy state-a positive buoyancy state.

When installed in an AUV such as underwater glider 2 (FIG. 1) or float 20 (FIG. 2), the drive mechanism 52/72 is primarily inside positioned inside the streamlined glider body 4 (FIG. 1) or float body 22 (FIG. 2) and the external bladder 58/78 is positioned external to the streamlined glider body 4 (FIG. 1) or float body 22 (FIG. 2) (not shown in FIG. 1). The deformable SMA actuator 62/82 can be configured in any convenient shape and/or size to cause piston 60/80 to move in reservoir 56/76 as desired. For example, deformable SMA actuator 62 may be in a spring-like configuration as shown in FIGS. 4A-4B. Alternately, the deformable SMA actuator 82 may be in a ball-like configuration as shown in FIG. 5A-5B. The deformable SMA 62/82 actuator should have sufficient mechanical strength to be able to cause piston 60/80 to move in reservoir 56/76 between a first position representative of a first buoyancy state (FIG. 4A/5A) to a second position representative of a second buoyancy state (FIG. 4B/5B) at anticipated operational depths in the underwater environment in which the AUV is designed to operate. A person of ordinary skill will recognize that other deformable SMA actuator 62/82 configurations are feasible. Also, a person of ordinary skill will recognize that other piston 60/80 configurations are feasible. The deformable SMA actuator 62/82 can be made from any SMA materials that are compatible with the variable buoyance engine 50/70 of the present disclosure. For example, the SMA materials can be a copper-aluminum-nickel alloy, a nickel-titanium alloy, an iron-manganese-silicon alloy, a copper-zinc-aluminum alloy, or other alloys of zinc, copper, gold, and iron. Depending on the application, a nickel-titanium alloy might be particularly suitable because of its stability and thermo-mechanic performance. As is known, SMAs can undergo shape changes due to temperature change induced phase or crystalline structure changes.

In the variable buoyance engine 50/70, power source 64/84 generates sufficient energy to cause deformable SMA actuator 62/82 to undergo a desired shape change as a result of a temperature change. The temperature change can be generated by a resistance heater (not shown) or other heating device connected to the power source 64/84. Depending on the application, power source 64/84 can be a battery or other energy storage device. Controller 66/86 is configured to cause power source 64/84 to induce a temperature change (e.g., either an increase or decrease in temperature) to cause deformable SMA actuator 62/82 to undergo the desired shape change and move the piston 60/80 from the first position (FIG. 4A/5A) to second position (FIG. 4B/5B) or vice versa. Controller 66/86 can be configured to cause power source 64/84 to induce a temperature change in response to sensed conditions of the AUV, such as depth, orientation, geographic location, etc.

The non-compressible working fluid may be any non-compressible fluid suitable for a particular application. For example, the non-compressible working fluid may be an oil, such as a mineral oil. In some applications, water or a water-based solution could be used as the non-compressible working fluid. Flowing the non-compressible working fluid from the reservoir 56/76 (FIG. 4A/5A) to the external bladder 58/78 (FIG. 4B/5B) causes the overall volume of the variable buoyance engine 50/70 to change. Because there is no change in the mass of the variable buoyance engine 50/70 with change in volume, changing the overall volume of the variable buoyance engine 50/70 results in the buoyancy of the variable buoyance engine 50/70 changing as described above.

An AUV such as underwater glider 2 or float 20 can be propelled in an underwater environment by placing an AUV with a variable buoyance engine 50/70 into an underwater environment. The AUV can be controlled through a period of descending in the underwater environment when the variable buoyance engine 50/70 is in a first, negative buoyancy state. Similarly, the AUV can be controlled through a period of ascending in the underwater environment when the variable buoyance engine 50/70 is in a second, positive buoyancy state. For an underwater glider 2 as depicted in FIG. 1, the plurality of hydrofoils 6 direct the streamlined glider body 4 in a forward direction when the streamlined glider body 4 changes depth due to changes in buoyancy state. For a float 20 as depicted in FIG. 2, the float body 22 generally changes depth due to changes in buoyancy state either with only limited changes in lateral position or changes in lateral position due to currents prevailing in its underwater environment.

As discussed, using a deformable SMA actuator 62/82 to drive a piston 60/60 instead of a motor and gearing results in a variable buoyance engine 50/70, shown in FIGS. 4A and 4B, that generates less electrical and acoustic noise than prior art systems. As result, an AUV with a variable buoyance engine 50/70 can be more effective than a similar AUV using prior art variable buoyance engines.

### Discussion of Possible Embodiments

The following are non-exclusive descriptions of possible embodiments of the present invention.

A variable buoyance engine comprises a pressure vessel, a reservoir, an external bladder in fluid communication with the reservoir, a non-compressible fluid disposed inside the reservoir and the external bladder, and a drive system disposed inside the reservoir. The drive system comprises a deformable shape memory alloy actuator, a piston attached to the deformable shape memory alloy actuator, a power source connected to the deformable shape memory alloy actuator, and a controller configured to control application of power from the power source to the deformable shape memory alloy actuator. The power source is configured to cause the deformable shape memory alloy actuator to change temperature and deform when power is applied to the deformable shape memory alloy actuator thereby moving the piston from a first position to a second position. The reservoir and external bladder are configured to retain without leakage the non-compressible working fluid. The external bladder is configured to receive the non-compressible working fluid from the reservoir when the deformable shape memory alloy actuator moves the piston from a first position to a second position to create a second, positive buoyancy state and to expel the non-compressible working fluid from the external bladder to the reservoir when the deformable shape memory alloy actuator moves the piston from the second position to the first position to create a first, negative buoyancy state.

The variable buoyance engine of the preceding paragraph can optionally include, additionally and/or alternatively, any one or more of the following features, configurations and/or additional components:

A further embodiment of the foregoing variable buoyance engine, wherein the drive system comprises a plurality of deformable shape memory alloy actuators.

A further embodiment of the foregoing variable buoyance engine, wherein the non-compressible working fluid comprises an oil.

A further embodiment of the foregoing variable buoyance engine, wherein the non-compressible working fluid comprises water or a water-based solution.

An autonomous underwater vehicle comprises an underwater vehicle body configured to operate in an underwater environment. The autonomous underwater vehicle further comprises the foregoing variable buoyance engine. The pressure vessel is part of the structure of the underwater vehicle body, the reservoir is positioned inside the underwater vehicle body, and the external bladder is positioned external to the underwater vehicle body. The underwater vehicle body is configured to descend in the underwater environment when the variable buoyance engine is in a first, negative buoyancy state and the streamlined glider body is configured to ascend in the underwater environment when the variable buoyance system is in a second, positive buoyancy state.

The autonomous underwater vehicle of the preceding paragraph can optionally include, additionally and/or alternatively, any one or more of the following features, configurations and/or additional components:

A further embodiment of the foregoing autonomous underwater vehicle, wherein the drive system comprises a plurality of deformable shape memory alloy actuators.

A further embodiment of the foregoing autonomous underwater vehicle, wherein the non-compressible working fluid comprises an oil.

A further embodiment of the foregoing autonomous underwater vehicle, wherein the non-compressible working fluid comprises water or a water-based solution.

A method for propelling an autonomous underwater vehicle in an underwater environment comprises providing the foregoing autonomous underwater vehicle in an underwater environment, controlling the autonomous underwater vehicle through a period of descending in the underwater environment when the variable buoyance system is in a first, negative buoyancy state; and controlling the autonomous underwater vehicle through a period of ascending in the underwater environment when the variable buoyance system is in a second, positive buoyancy state.

The method for propelling an autonomous underwater vehicle in an underwater environment of the preceding paragraph can optionally include, additionally and/or alternatively, any one or more of the following features, configurations and/or additional components:

A further embodiment of the foregoing method for propelling an autonomous underwater vehicle in an underwater environment, wherein the drive system comprises a plurality of deformable shape memory alloy actuators.

A further embodiment of the foregoing method for propelling an autonomous underwater vehicle in an underwater environment, wherein the non-compressible working fluid comprises an oil.

A further embodiment of the foregoing method for propelling an autonomous underwater vehicle in an underwater environment, wherein the non-compressible working fluid comprises water or a water-based solution.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A variable buoyance engine comprising:
a pressure vessel;
a reservoir;
an external bladder in fluid communication with the reservoir;
a non-compressible fluid disposed inside the reservoir and the external bladder; and
a drive system disposed inside the reservoir, wherein the drive system comprises:
a deformable shape memory alloy actuator;
a piston attached to the deformable shape memory alloy actuator;
a power source connected to the deformable shape memory alloy actuator, wherein the power source is configured to cause the deformable shape memory alloy actuator to change temperature and deform when power is applied to the deformable shape memory alloy actuator thereby moving the piston from a first position to a second position;
a controller configured to control application of power from the power source to the deformable shape memory alloy actuator;
wherein the reservoir and external bladder are configured to retain without leakage the non-compressible working fluid and wherein the external bladder is configured to receive the non-compressible working fluid from the reservoir when the deformable shape memory alloy actuator moves the piston from a first position to a second position to create a second, positive buoyancy state and to expel the non-compressible working fluid from the external bladder to the reservoir when the deformable shape memory alloy actuator moves the piston from the second position to the first position to create a first, negative buoyancy state.

2. The variable buoyance engine of claim 1, wherein the drive system comprises a plurality of deformable shape memory alloy actuators.

3. The variable buoyance engine of claim 1, wherein the non-compressible working fluid comprises an oil.

4. The variable buoyance engine of claim 1, wherein the non-compressible working fluid comprises water or a water-based solution.

5. An autonomous underwater vehicle comprising:
an underwater vehicle body configured to operate in an underwater environment; and
a variable buoyance engine of claim 1, wherein the pressure vessel is part of the structure of the underwater vehicle body, the reservoir is positioned inside the underwater vehicle body, and the external bladder is positioned external to the underwater vehicle body;
wherein the underwater vehicle body is configured to descend in the underwater environment when the variable buoyance system is in a first, negative buoyancy state and the underwater vehicle body is configured to ascend in the underwater environment when the variable buoyance system is in a second, positive buoyancy state.

6. The autonomous underwater vehicle of claim 5, wherein the underwater vehicle is a float, the underwater vehicle body is a float body, and the underwater vehicle body is configured to neither descend nor ascend in the underwater environment when the variable buoyance system is in a third, neutral buoyancy state.

7. The autonomous underwater vehicle of claim 5, wherein the underwater vehicle is an underwater glider and the underwater vehicle body is a streamlined glider body, wherein the underwater glider further comprises:
a plurality of hydrofoils configured to direct the streamlined glider body in a forward direction when the streamlined glider body changes depth due to changes in buoyancy state; and
a vertical stabilizer configured to orientation of the streamlined glider body along a longitudinal axis.

8. The autonomous underwater vehicle of claim 5, wherein the drive system of the variable buoyance system comprises a plurality of deformable shape memory alloy actuators.

9. The autonomous underwater vehicle of claim 5, wherein the non-compressible working fluid comprises an oil.

10. The autonomous underwater vehicle of claim 5, wherein the non-compressible working fluid comprises water or a water-based solution.

11. A method for propelling an autonomous underwater vehicle in an underwater environment, comprising:
providing an autonomous underwater vehicle in an underwater environment, wherein the autonomous underwater vehicle comprises:
an underwater vehicle body configured to operate in an underwater environment; and
a variable buoyance engine comprising:
a pressure vessel;
a reservoir;
an external bladder in fluid communication with the reservoir;
a non-compressible fluid disposed inside the reservoir and the external bladder; and
a drive system disposed inside the reservoir, wherein the drive system comprises:
a deformable shape memory alloy actuator;
a piston attached to the deformable shape memory alloy actuator;
a power source connected to the deformable shape memory alloy actuator, wherein the power source is configured to cause the deformable shape memory alloy actuator to change temperature and deform when power is applied to the deformable shape memory alloy actuator thereby moving the piston from a first position to a second position;
a controller configured to control application of power from the power source to the deformable shape memory alloy actuator;
wherein the reservoir and external bladder are configured to retain without leakage the non-compressible working fluid and wherein the external bladder is configured to receive the non-compressible working fluid from the reservoir when the deformable shape memory alloy actuator moves the piston from a first position to a second position to create a second, positive buoyancy state and to expel the non-compressible working fluid from the external bladder to the reservoir when the deformable shape memory alloy actuator moves the piston from the second position to the first position to create a first, negative buoyancy state,
wherein the pressure vessel is part of the structure of the underwater vehicle body, the reservoir is positioned inside the underwater vehicle body, and the external bladder is positioned external to the underwater vehicle body;
wherein the underwater vehicle body is configured to descend in the underwater environment when the variable buoyance system is in a first, negative buoyancy state and the underwater vehicle body is configured to ascend in the underwater environment when the variable buoyance system is in a second, positive buoyancy state;
controlling the underwater vehicle through a period of descending in the underwater environment when the variable buoyance system is in a first, negative buoyancy state; and
controlling the underwater vehicle through a period of ascending in the underwater environment when the variable buoyance system is in a second, positive buoyancy state.

12. The method of claim 11, wherein the drive system of the variable buoyance system comprises a plurality of deformable shape memory alloy actuators.

13. The method of claim 11, wherein the non-compressible working fluid comprises an oil.

14. The method of claim 11, wherein the non-compressible working fluid comprises water or a water-based solution.

15. The method of claim 11, wherein the underwater vehicle is an underwater glider and the underwater vehicle body is a streamlined glider body, wherein the underwater glider further comprises:
a plurality of hydrofoils configured to direct the streamlined glider body in a forward direction when the streamlined glider body changes depth due to changes in buoyancy state; and
a vertical stabilizer configured to orientation of the streamlined glider body along a longitudinal axis;
wherein the plurality of hydrofoils direct the streamlined glider body in a forward direction when the streamlined glider body changes depth due to changes in buoyancy state.

16. The method of claim 11, wherein the underwater vehicle is a float and the underwater vehicle body is a float body and the method further comprises:
establishing neutral buoyance state operational conditions for the underwater vehicle based on conditions of the underwater environment and the mass and volume of the underwater vehicle, such that the neutral buoyancy state corresponds to a desired depth in the underwater environment; and
controlling the underwater vehicle through a period of neither descending nor ascending in the underwater environment when the variable buoyance system is in a third, neutral buoyancy state.
